(19) United States
(12) Patent Application Publication
(10) Pub. No.: US 2008/0072071 A1
(43) Pub. Date: Mar. 20, 2008

(54) Hard disc streaming cryptographic operations with embedded authentication

(75) Inventors: Monty Aaron Forehand, Loveland, CO (US); Laszlo Hars, Cranberry Township, PA (US); Robert Wayne Moss, Longmont, CO (US); Donald Preston Matthews, Longmont, CO (US); Robert Harwell Thibadeau, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/521,248

(22) Filed: Sep. 14, 2006

(51) Int. Cl. H04L 9/00; G06F 12/14; H04K 1/00; H04L 9/32; G06F 11/30

(52) U.S. Cl. 713/193; 713/183; 380/44

(57) ABSTRACT

A data storage system comprises a storage element, and an encryption and decryption unit connected between a host and the storage element, and using a key that is generated in the data storage system.

### FIELD OF THE INVENTION

This invention relates to data storage devices and more particularly data storage devices that implement cryptographic operations.

### BACKGROUND OF THE INVENTION

Users and consumers of disc drives require that when their data is stored, it is stored in a secure fashion, such that it cannot be retrieved, unless the proper credentials can be presented. A well-known problem among users of computers comes at the point where the computer needs to be secured, upgraded, replaced, transitioned to a different use, or disposed of. The non-volatile storage on the computer, typically one or more disc drives, contains private data. Often the task of even determining the data that can be retrieved from a disc is sufficiently difficult and inconvenient that disc drives are physically destroyed or stored with physical security despite the fact that they are perfectly functional and may be repurposed.

Users and consumers require a mechanism to quickly and easily dispose of disc drives, while ensuring that some other party cannot retrieve their data. It is known that it is very difficult and time-consuming to actually erase all magnetic traces of the user's data on magnetic media. Users and consumers require a more efficient and conclusive method to dispose of their drives and be assured that their data will not be revealed.

The usual proposed solution to this problem is to control access to the disc contents, repartition, reformat, or rewrite the disc. In all these cases, the task takes time and effort. If the reason for disposal is a failure of the computer main board, then the disc must be connected to another computer in order to repartition, reformat, or rewrite the disc. If the data is access controlled, simply putting the disc in another computer, with a different operating system, is usually sufficient to read the contents. The shorter and more convenient tasks of access control or repartitioning, do not leave the data on the disc in an unreadable state. For a given disc it is not generally known whether reformatting or rewriting is sufficient to protect the data owing to the plurality of technologies, so there is no guarantee that rewriting is sufficient. But it is generally true that the actions that take seconds such as partitioning are less secure than actions that take many minutes such as reformatting or rewriting.

Attempting to solve this problem external to the disc drive results in multiple physical and logical avenues, whereby the integrity and secrecy of the user's data and communications can be compromised. Using external keys and dongles can result in unmanageable key and dongle distribution problems, with the large distribution of disc drives. Additionally, external solutions require specific hardware and software, and in some cases connections must be added to the host system. These solutions would be unmanageable across a broad applications space. Additionally, external solutions would suffer from limited configurability to the user's specific end application.

Whole disc encryption provides a solution to this problem by using a short key, only a few bytes long, which can be removed during times the computer user or owner wishes to secure or repurpose the computer. Encrypting data on a disc is a well-known method for achieving data confidentiality for files. Well-known encryption techniques exist, such as 3DES and AES, which afford great confidence that, without the key, the data cannot be read.

Whole disc encryption has another feature for creating a tamper evident environment. In other solutions, it is not possible to show that files have not been tampered with, or altered, in order to achieve a malicious effect. However, since the files and file structure itself strongly resists exposure in whole disc encryption, the attacker is left having to delete the entire disc and this exposes a malicious action and thereby opens the attacker to discovery.

Well-known file and disc encryption products are often software products that run in the host computer. These are low security because the keys, used to perform the encryption and decryption, can be read. Whole disc encryption in hardware is used in existing products. In some cases the encryption hardware is in the electronics attached to the disc drive and in others it is in the interface (e.g., ATA or SCSI interface) to the drive. However, those cases provide a singular, inflexible, method for key management.

In disc drives, and many similar storage devices, controllers make use of high speed interfaces and buffer memory to optimize reading and writing data to media. Ideally a cryptographic system for encrypting data, and for authentication and other cryptographic functions, should fit neatly within existing designs and yet provide maximum versatility and performance.

A versatile solution would allow the key to be used, stored, and managed in a plurality of ways that suits individual needs while affording great convenience as well as good performance. There is a need for a system that addresses these problems, in a way that the solution can be used in a multitude of disc drive and data application spaces.

### SUMMARY OF THE INVENTION

This invention provides a data storage system comprising a storage element, and an encryption and decryption unit connected between a host and the storage element, and using a key that is generated in the data storage system.

The key can be generated by a cryptographic and security module that can include a root key. The storage element can include a secure partition that contains one or more keys.

In another aspect, the invention provides a data storage system comprising a storage element, a hardware cryptographic unit connected between a host and the storage element, and a virtual smart card controlling the hardware cryptographic unit.

The virtual smart card can include a root key. The key can be encrypted using a password.

### BRIEF DESCRIPTION OF THE DRAWINGS

FIG. 1 is a block diagram of a computer system including a data storage device constructed in accordance with an embodiment of this invention.

FIG. 2 is a block diagram of a computer system including a data storage device constructed in accordance with another embodiment of this invention.

### DETAILED DESCRIPTION OF THE INVENTION

For data storage devices such as disc drives, there is a desire to secure the user's data and communications, and to provide integrity of the user's data and communications on the disc drive. To do this, it is desirable to perform cryptographic operations such as encryption and hashing of the commands and data as they enter and leave the disc drive. Additionally, it is best to do this in a secure environment on the drive itself as opposed to external to the drive, where there is more opportunity for interception of these transactions.

This invention has two aspects. In the first aspect, the apparatus provides streaming cryptographic operations in a disc drive. The second aspect uses virtual smart cards as the authentication and controlling mechanism for doing streaming cryptographic operations.

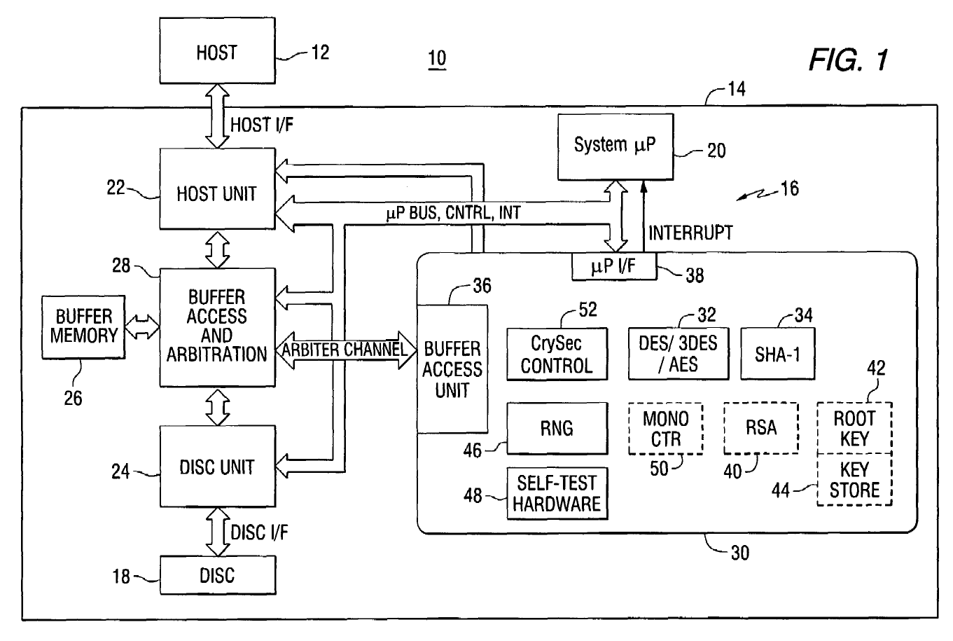

FIG. 1 is a block diagram of a computer system 10 that includes a host computer 12 and a data storage device 14, in the form of a disc drive, constructed in accordance with an embodiment of this invention. The data storage device provides streaming cryptographic operations, and includes a controller 16 and a storage medium 18. The controller includes a system microprocessor 20, a host unit 22, a disc unit 24, a buffer memory 26, a buffer manager or buffer access and arbitration circuit 28, and a cryptographic and security module 30. The cryptographic and security module 30 contains a symmetric encryption module or cipher block 32, a hashing module 34, a buffer access unit/direct memory access (DMA) 36, a microprocessor interface 38, an asymmetric encryption acceleration module 40, a root key 42, a key store 44, a random number generator (RNG) 46, self-test hardware 48, a monotonic counter 50, and a command controller 52 for receiving and interpreting commands from the drive firmware.

The symmetric cipher block 32 is used to provide symmetric encryption of data in the cryptographic and security module. In one example the symmetric encryption module can include Advanced Encryption Standard (AES) and Triple Data Encryption Standard (DES) algorithms. The hash module 34 is provided for hashing of data. The hash module can be implemented using an SHA-1 Algorithm. The asymmetric encryption acceleration module 40 can use, for example, a 1024 and 2048 bit Rivest, Shamir, Adleman (RSA) algorithm.

The system microprocessor interface 38 provides the connection between the cryptographic and security module and the system microprocessor. This connection is used to transfer commands to and retrieve status from the cryptographic and security module. In one embodiment, this connection is a parallel address and data bus, but it may also be implemented with a serial port connection.

The system microprocessor interface also includes a hardware interrupt signal line 56 that attaches directly to the system microprocessor interrupt controller. This interrupt will be used to notify the system microprocessor of the completion of a command, and of results available in the buffer.

The cryptographic and security module contains an internal command bus and data bus for communication amongst internal sub-circuits and a block pipeline bus for chaining of cryptographic operations. The buffer access unit and microprocessor interface circuitry adapt data flow to the protocols of the respective attached busses.

A monotonically increasing counter circuit 50 provides for secure knowledge of relative time. The cryptographically good random number generator 46 provides random numbers with technical infeasibility of prediction. The key store 44 can be a volatile memory for storing temporary keys.

The command controller 52 is provided for receipt and decoding of commands received from the system microprocessor and for tasking of the sub-circuitry. The command controller has the primary responsibility for decoding commands and setting microprocessor sub-blocks for the desired operation, and data flow. The command controller can also sequence the operations required to perform the RSA computations.

To preserve the integrity of access to the cryptographic and security module it is important that there be no alternate accessibility to the cryptographic and security module, outside of the defined command interface described above. This will ensure that attackers cannot make malicious access to the module using debug or manufacturing pathways. Because of these constraints, the module can include an internal self-test unit.

This self-test unit can be used to verify the correct functionality of the module while preventing “back-door” access to the cryptographic and security module. The self-test module can also be invoked during normal operation of the chip, in a drive, to verify continued correct functionality of the cryptographic and security module. The self-test hardware 48 autonomously ensures correct functionality of the cryptographic and security circuitry.

The cryptographic and security module is coupled to the disc unit 24 through the buffer manager 28. The buffer memory 26 stores various information designated as source data, result data, command queue, and result queue. The buffer manager provides buffer access and arbitration. The host unit 22 interacts with the buffer manager. The drive microprocessor 20 is coupled to the host unit, buffer manager, disc unit, and the cryptographic and security module.

The apparatus of FIG. 1 provides streaming cryptographic operations in conjunction with a secure hardware and firmware system, to facilitate the integrity and secrecy of the streaming hardware operations. The system includes cryptographic electronics in the disc drive host interface (also called the host unit) that provides for at-speed (e.g., streaming) cryptographic operations performed on the data and commands that pass through the host interface. Additionally, the system provides an isolated crypto and security module to provide the keys, initial values, random numbers, and other security mechanisms to the streaming cryptographic electronics unit. The system microprocessor runs security routines that provide overall control of the system, and provides for authentication of users.

An encryption/decryption key is generated within the storage device and stored in a location that is not accessible from outside the storage device. In a whole disc encryption system, generating a new key is equivalent to cryptographically erasing the storage device. The root key can be generated in a silicon die of the processor. A password can be used to provide a separate security mechanism. The password can be used to further encrypt the key generated by the storage device, for example, from a root key.

FIG. 1 shows a disc drive that has one or more inline symmetric cryptographic units coupled with a subsystem, which is root key protected for on-board authentication, key exchange, and integrity management. This combination permits various types of desirable high speed processing including but not limited to: (a) interface speed encryption of data to the media and decryption from the media in disc unit 24; (b) interface speed encryption of data for transport and decryption of data from transport in the host unit 22; (c) additional hashing of the data, along with verification of signature or signing of the hash in the cryptographic and security module; and (d) key management for the various functions in the cryptographic and security module. A masked root key in a secure location, in combination with a random number generator, is used for on-board key generation.

The embodiment of FIG. 1 includes components of a conventional disc controller in the form of items 12, 18, 20, 26 and 28, but includes additional components that modify an existing conventional disc controller design to add cryptographic processing of user data on the storage element or storage media, along with authentication/key exchange/integrity processing.

In one example, the master password that is not machine readable can be printed on the label of the disc drive. This master password can be recognized but not read electronically. The master password may be set by default, in manufacturing of the storage device, to a random key value that is large enough that the likelihood of two storage devices ever having this key value is essentially zero. For example a 16 or 20 byte value has this property. This master password is not machine readable by any means from the storage device. It would be available to the storage device owner by another means, such as reading the printed matter attached to the storage device, reading printed matter supplied with the storage device, or going to a web location and using the serial number to look up the master password. This protects against network based attacks on storage device security, insures that the master passwords are strong, and doesn't require user intervention to set a master password. The user only needs this password when he wishes to dispose of the storage device. The master password can be used for repurposing the disc drive.

While the above description shows the streaming cryptographic operations being performed in the host interface block, the system also allows for streaming cryptographic operations to be performed in the disc block of the system, or another block in the system or drive. Additionally, there may be multiple streaming cryptographic blocks in the system. Alternatively, there may be multiple streaming cryptographic blocks in a given system block to support re-crypto operations when the received information has had a previous crypto operation performed, and that operation is to be reversed or confirmed. Then a new operation would be performed on the information, prior to passing the information to the rest of the system. An example of this would be re-encryption, where data is received from the host in an encrypted format, decrypted, and then re-encrypted with a new key that is secret to the drive.

This system is not confined to any single cryptographic operation. It can be applied using encrypt/decrypt, hashing, or many other operations. The above description does not limit the system partitioning or the functionality in the disc drive. The specific implementations could be contained in a single IC (Integrated Circuit), or multiple ICs on a disc drive.

In another aspect, the invention provides streaming cryptographic operations using virtual smart cards. Using the above described system, a mechanism is employed which uses virtual smart cards to provide the authentication and security infrastructure needed to support the security and integrity of the streaming cryptographic operations, and the security and integrity of the information at rest and in transit on the drive. These virtual smart cards are facilitated by secure firmware routines working in conjunction with the cryptographic and security module.

U.S. Pat. No. 7,036,020, the disclosure of which is hereby incorporated by reference, shows a versatile method for protecting data in a storage device that requires something more than simply a data encryption facility, but also includes facilities for user and device authentication, key management, and secure data transmission to other trusted end points. The present invention can use these facilities to protect and manage the lifecycle of one or more cryptographic keys (K). Hidden space on the data storage medium is hidden at the level of low level drive formatting, and can be protected from whole volume encryption because no user command can write (or read) this space. These spaces are called Security Partitions, (SPs). One SP may be utilized to manage one or more keys for one or more storage volumes. Data in an SP, including the keys, can optionally be encrypted using a different key.

Multiple security partitions can be provided on a single storage device, with each security partition using virtual interfaces associated with a smart card. As used herein, a smart card is an integrated chip security device capable of protecting data. A virtual interface uses smart card commands and data structures to provide smart card functionality. Such commands and data structures can be, for example, compliant with international standard ISO-7816. The combination of a virtual interface with the functionality of traditional smart cards results in a virtual smart card. Thus virtual smart cards are a firmware and storage device embodiment of a smart card in a security partition.

Virtual smart cards can be provided to support a secure messaging and communication structure for transactions within the drive and transactions with the host interface. These virtual smart cards are used to establish integrity, trust, and credentials for access to various information on the disc drive. More specifically, the virtual smart cards are used to establish integrity, trust, and credentials that can be used for enabling and disabling the streaming cryptographic module. The virtual smart card can also provide the keys and other secrets that are used by a security module.

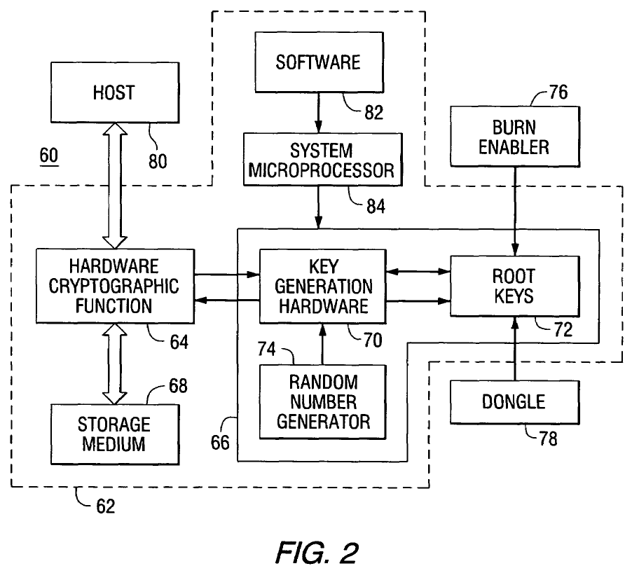

FIG. 2 is a block diagram of a computer system 60 including a data storage device 62 constructed in accordance with another embodiment of this invention. The data storage device provides streaming cryptographic operations, and includes a hardware cryptographic unit 64, a virtual smart card 66, and a storage medium 68. The virtual smart card includes key generating hardware 70, a root key storage device 72, and a random number generator 74. Inputs 76 and 78 are provided to enable burning of the root key and the connection of a dongle. The hardware cryptographic unit 64 is connected between the host computer 80 and the storage medium 68 to provide full disc encryption. Software 82 is used by a processor 84 in the storage device to perform data operation requests and for status monitoring. The software does not have access to the keys and random numbers used by the hardware to perform the encryption function.

The system of FIG. 2 can include a monotonic counter, in the key generation hardware, whose value is stored in some non-volatile memory. The counter would only be incremented by hardware. On power-up, the hardware automatically loads the counter value from a random location, which has the encrypted count value. The counter is then incremented and the count value is stored to a different location with different keys. This operation is performed with hardware so that the counter value cannot be corrupted by software. Also, the software need not even know what the count is. The counter hardware could have a count compare function, which would allow the software to compare a count, without the software knowing the count. In addition, the count loading hardware can hold-off the software execution by asserting a hardware rest to the microprocessor element.

Circuitry for full disc encryption can reside in a separate chip or an externally attached module. A separate physical key could also be provided. Upon the first mating of the full disc encryption module, the physical key, and the drive, the three components could authenticate themselves to each other, even burning the key into non-volatile memory.

Using the above described systems, a user's information is securely hidden on the disc drive, and the user can dispose of or transfer a drive, while absolutely ensuring the secrecy of latent information on the drive. In addition to user data, the security capabilities can also be applied to commands, drive history logs, configuration parameters, mode settings, and other information contained in the drive.

A secure table can be used to keep track of all copies of the security partitions that may contain copies of keys that are employed for encryption. A means of managing basic secrets from many sources that may be needed to reveal the secret key(s), such as a removable token, can be included for loading on power-up. Conventional ATA or SCSI password authentication can be used to provide the basic secret needed to reveal the secret key(s).

In one embodiment, the encryption machinery is in the drive electronics. It is necessary for the encryption machinery to have access to the encryption key K during encryption and decryption. During this time, exposure of K is possible, although suitable electronics blinding techniques can reduce the possibility of direct electromagnetic discovery. Also, the storage device can be protected with a physical tamper evident wrapping or other technique that may readily reveal if K may have had a physical attack against it. At other times, K may be stored in one or more of five basic places: (a) in a non-volatile solid state storage SP in the drive electronics, (b) in an SP on the disc media, (c) in a secure container (blob) in the host, (d) in a secure container or another SP in another host out on a network, or (e) in a separate non-volatile storage device SP directly connected to the drive electronics (e.g., attached to a serial port).

The encryption machinery in the drive electronics can be the only location where the key is known in plain text. A second key, a root key, RK, which is only known to the drive electronics but which cannot encrypt or decrypt data from the drive, can be employed to encrypt or decrypt K. The root key may be inexpensively produced by permanent fusing, although other well-known techniques may be employed as well. The encrypted version of K is Ke. The encryption technique used to obtain Ke can utilize the encryption machinery (e.g., 3DES or AES) described above.

Now it should be clear that Ke can be stored without fear of the actual K being discovered. As long as the desired purpose of encryption is whole volume encryption and decryption, then this relatively simple method works in all cases. It should also be clear that this method could work in cases providing a block-by-block or file-by-file encryption service using a plurality of keys.

To secure a volume, it is necessary to remove Ke and K from the drive electronics. Removing Ke may be as simple as replacing Ke with K, as Ke is recovered from K using the hidden root key, RK. However, all locations where Ke exists must now be examined and Ke must be denied to the drive electronics. In the case of permanent disc disposal, this can be done by simply deleting all copies of Ke.

In one embodiment, K may be generated as a random number in the drive electronics and read out only as Ke. This further reduces the likelihood of K being discovered.

If the user desires to use the same K over a plurality of drives, then he may use the mechanisms of the SP to perform the key management. In one example, if the drive electronics do not support a hardware protected RK for Ke and secure handling of the derived K, then an SP on the drive can be configured with a RK which cannot be read off the drive and the Ke stored on the SP or any of the other locations. In this case, a physical attack is easier but tamper evident packaging may, again, mitigate the risk.

The SPs provide a method for keeping track of all copies of the Ke. This can be done with public key cryptography. An SP in this case keeps a list of all public keys of all authorities permitted to read the Ke or to write the Ke. Each authority must cryptographically prove it is requesting to read or write the Ke using well-known signing and verification, and the Ke is securely sent to the target SP using well-known public key encryption and decryption. Each SP can have the table of all SPs permitted to hold the Ke and thereby a means of tracking down all copies of the Ke. More generally, this same table could hold different Ke's for many different volumes and thereby permit redundancy while assuring that all Ke's can be tracked and eliminated or held in abeyance as specified by host commands.

The SP on the target volume may also have this table. In this case it may be sufficient to mark this SP as having this drive's Ke eliminated in order to ensure that a copy of the Ke on any other SP cannot later be written back to the target volume SP. However, since a goal is to physically eliminate the Ke from the target volume SP, there can be a globally unique identifier, which may be encrypted with the K in the Ke. A list of invalid identifiers on the target SP would be examined to determine if K has been permanently disposed of, thereby deny writing of the voided Ke copy to the target volume SP. This also provides a positive feature that it would be possible with the right knowledge of the electronics and the right equipment to bypass this protection and reinsert a Ke that had previously been made invalid. If the user does not desire this feature, then steps must be taken to be certain that all copies of the Ke have been destroyed. As above, he does this by utilizing the SPs to maintain the record of where all the Ke's are.

The root key (RK) provides a convenient and effective mechanism for masking the K and optionally associating it with an index to K. However, it does not insure that SPs cannot be impersonated and thereby provide a means by which a Ke copy can be kept by an impersonator. To address this issue, the whole disc may have a public/private key chain (for example, a signing and exchange key pair on the Administrative SP) with certificates signed by the drive manufacturer that can attest to the fact that the volume contains legitimate SPs. No table entry for a Ke would contain a public verification and exchange key unless those keys are proven to be associated with legitimate manufacturer SPs. The RK on the drive can additionally be employed to encrypt the private keys of these key pairs and thereby deny their use off the disc drive.

Table 1 is a table of Ke's.

TABLE 1

| | | | Exchange | | |
|---|---|---|---|---|---|
| Identifier | Ke | Sign Cert | Cert | State | Master |
| 24 Bytes | 16 Bytes | 4096 Bytes | 4096 Bytes | Valid/ | Yes/No |
| | | | | Voided | |

Note that if a Ke is voided, it is also erased from the table, although the identifier remains. The public keys (PuKs) can be erased but such erasure is optional.

The table can be extended to mark the master copy of the Ke. With a master copy, the drive firmware can ensure that no copy can be made of a copy. Copies of Ke can only be made of the master and only deleted by a master. This provides a ready means of tracking down all copies and of assuring that all tables are current and synchronized.

This invention uses an encryption method to enable safe disposal of magnetic storage media and safe repurposing of the discs. The secret is held in a non-volatile store that cannot be read once the secret is removed. This secret may only be a few bytes of data. The secret is employed either directly as a symmetric encrypting/decrypting key for substantially all the data that is written to or read from the magnetic storage. Removing, or changing, this key can be protected by employing a public key cryptosystem, also associated with the controller interface, where the public keys necessary to recognize the authority to change the secret encrypting key are on the storage unit. The symmetric encrypting algorithm may be 3DES or AES or another algorithm suitable to the circumstance and the disposal safety level required.

Alternative embodiments would: (a) move the secret to a remote location that is only dynamically loaded on the drive on power-up; (b) move a basic secret to a remote location, which is then cryptographically combined with a secret kept on the media in order to derive the necessary encrypting key; (c) have the secret or basic secret in a removable token attached to the storage controller; or (d) move the encryption to the host and optionally using a cryptographic token to secure the secret. In (c), replacement of the token with a different one would allow safely repurposing the storage.

Encrypting storage devices that use industry standard interfaces, including but not limited to the ATA or SCSI interfaces, generally require special software on the platform host to perform changes of state in the encrypting storage devices. Several changes of state changes are of interest in this context. First, for password authorization for use of the storage device, the user must type in a passcode in order to gain access to the key that decrypts and encrypts data from and to the device. Second, when replacing the key for secure storage device disposal or repurposing, the key must be changed in order to leave the device in a state where it can be used without concern about exposing previously written data. Third, a master password can be inserted for protecting the key replacement action from malicious or accidental change.

In all of these cases, the unwanted side effect of the security is that a user action is required and that it is common to have to create special host platform software to perform these functions. Embodiments of the present invention can incorporate the following mechanisms to perform these state change requirements.

Password authorization can use the existing ATA or SCSI etc. password authorization. However, now instead of turning the read/write off and on, the password is cryptographically mixed with a stored base key on the device in order to derive the encryption/decryption key that is effective. The encryption/decryption key is not on the device when the device is authenticated. Existing software, which uses a single password, controls encryption.

Key replacement can use the Secure Erase commands already built into ATA or SCSI etc. for securely erasing the storage device. No external software is required that does not already exist. This improves existing Secure Erase commands that take upwards of an hour on modern disc drives for example, which can now be effected nearly instantaneously. On the occurrence of a Secure Erase command, a new password is required for password authorization and the storage device is set back to its manufactured state with respect to password authorization. It is also possible to undo the Secure Erase if the user has not yet powered down the storage device.

The present invention need not be limited to whole disc encryption. It may also apply to whole partition encryption, or whole volume encryption that may span many disc drives. In addition, it is not limited to spinning disc storage units but can be applied to solid state storage or other types of non-volatile storage including volatile storage that requires constant power to maintain its data.

While the invention has been described in terms of several examples, it will be apparent to those skilled in the art that various changes can be made to the described examples without departing from the scope of the invention as set forth in the following claims.

What is claimed is:

1. A data storage system comprising:
a storage element; and
an encryption and decryption unit connected between a host and the storage element, and using a key that is generated in the data storage system.

2. The data storage system of claim 1, wherein the key is not accessible outside of the data storage system.

3. The data storage system of claim 1, further comprising:
a cryptographic and security module for generating the key.

4. The data storage system of claim 3, wherein the cryptographic and security module further comprises:
a key store for storing a root key.

5. The data storage system of claim 1, wherein the storage element comprises a disc, and the encryption and decryption unit provides full disc encryption.

6. The data storage system of claim 1, wherein the key is encrypted using a password.

7. The data storage system of claim 1, further comprising:
a secure partition in the storage element.

8. The data storage system of claim 7, wherein the secure partition contains a public key.

9. The data storage system of claim 7, wherein the secure partition contains a table of different keys.

10. The data storage system of claim 1, further comprising:
a plurality of secure partitions in the storage element, each having a table of secure partitions permitted to hold the key.

11. A data storage system comprising:
a storage element;
a hardware cryptographic unit connected between a host and the storage element; and
a virtual smart card controlling the hardware cryptographic unit.

12. The data storage system of claim 11, wherein the virtual smart card includes:
a root key.

13. The data storage system of claim 11, further comprising:
a secure partition in the storage element.

14. The data storage system of claim 11, wherein the key is encrypted using a password.

15. The data storage system of claim 11, further comprising:
a secure partition in the storage element.

16. The data storage system of claim 15, wherein the secure partition contains a public key.

17. The data storage system of claim 15, wherein the secure partition contains a table of different keys.

18. The data storage system of claim 11, further comprising:
a plurality of secure partitions in the storage element.

19. The data storage system of claim 18, further comprising:
a table of the secure partitions.
